(19) United States
(12) Patent Application Publication
(10) Pub. No.: US 2022/0161510 A1
(43) Pub. Date: May 26, 2022

(54) Pultrudates Having Elevations and Grooves and Method for Production Thereof

(71) Applicant: SIEMENS GAMESA RENEWABLE ENERGY SERVICE GMBH, Hamburg (DE)

(72) Inventors: Urs Bendel, Fockbek (DE); Michael Semling, Kiel (DE)

(21) Appl. No.: 17/421,413

(22) PCT Filed: Dec. 20, 2019
(86) PCT No.: PCT/EP2019/086780

§ 371 Date: Jul. 8, 2021

(30) Foreign Application Priority Data
Jan. 8, 2019 (DE) 10 2019 000 053.6

(51) Int. Cl. B29C 70/52; B29C 70/44; B29C 70/54; B29C 70/86; B29D 99/00; F03D 1/06

(52) U.S. Cl. CPC B29C 70/52; B29C 70/443; B29C 70/547; B29C 70/865; B29L 2031/082; B29D 99/0014; B29D 99/0028; F03D 1/0675; B29D 99/0007

(57) ABSTRACT

A pultrudate (1) with fibres running in the longitudinal direction (L) and a resin matrix which surrounds the fibres, and a top and a bottom side (2, 4), wherein the top side (2) has continuous elevations (5) and/or grooves (3) and the bottom side (4) has continuous grooves (3) or elevations (5), which are arranged such that elevations (5) and grooves (3) of one pultrudate (1) interact with grooves (3) and elevations (5) of the adjacent pultrudate (1′).

The invention relates to a pultrudate having fibres extending in the longitudinal direction and a resin matrix which surrounds the fibres and a top and bottom side. The invention also relates to a component of a rotor blade having at least two pultrudates arranged above one another. Furthermore, the invention relates to a method of producing a pultrudate and to a method of producing a component of a rotor blade.

Naturally, pultrudates are well known in the prior art. Pultrudates are fibre-reinforced plastic components which are produced in a pultrusion process and are also increasingly used for construction von rotor blades. Pultrudates are used there in particular in the production of girders.

Girders can be produced in separate production moulds. For this purpose pultrudates are laid alongside and above one another or stacked. The pultrudates laid alongside and above one another are covered with a vacuum film. After the sealing of the vacuum film at the edge of the production mould a vacuum is formed and a resin infusion method is carried out. In this case the resin penetrates between the pultrudate layers and alongside and between the pultrudate stacks, and in a subsequent heating process the resin cures and connects the pultrudates firmly to one another. Naturally, for the adhesion of the pultrudates it is significant that between the pultrudates which lie on top of one another the resin is distributed as uniformly as possible and over a large area in order to form an optimal adhesive surface area which is as large as possible. In order to facilitate a distribution of resin between the top and bottom sides of pultrudates which are stacked above one another, it is known for example from EP 3 069 017 B1 to provide the bottom sides of the pultrudates with continuous grooves, in which the resin can then run along in the infusion process and from there can be distributed between the pultrudates lying on top of one another. A disadvantage of the described infusion process is, on the one hand, that a resin infusion has to take place in the longitudinal direction of the pultrudate and thus of the girder. However, the dimensions in the longitudinal direction of a girder can be considerable, that is to say 40 to 120 m, and it is difficult to carry out a stable infusion process over such a long distance. Furthermore, the pultrudates are pressed strongly onto one another by the vacuum film, so that distribution out of the grooves between the pultrudates, in particular between the bottom side of the upper pultrudate and the top side of the lower pultrudate, is only insufficiently possible. A further aspect of the above-mentioned method which could prove disadvantageous is that the pultrudates have to be stacked one above the other in stacks and the stacks can slip with respect to one another in cross-section.

An object of the invention is to provide a pultrudate which reduces the above-mentioned disadvantages, preferably avoids them.

It is also an object of the invention to provide a component of a rotor blade in which the above-mentioned disadvantages are only reduced or do not occur at all.

Furthermore, it is an object of the invention to provide a method of producing one of the pultrudates and finally a method of producing a component of a rotor blade.

The invention achieves this object in its first aspect by a pultrudate referred to in the introduction with the characterizing features of claim 1.

The pultrudate according to the invention has on its top side continuous elevations and/or depressions and on the bottom side it has correspondingly reversed continuous depressions and/or elevations. The elevations and depressions are arranged in such a way that elevations and depressions of one pultrudate interact with depressions and elevations of an adjacent pultrudate. An adjacent pultrudate should be understood here as a pultrudate which rests with its bottom side on the top side of the adjacent pultrudate. Thus the pultrudates are stacked above one another and both are aligned in the longitudinal direction. Since the pultrudates mentioned here are usually formed in cross-section as narrow rectangles, the above-mentioned stacking operation can be carried out by having the bottom sides of the upper pultrudate resting on the top sides of the lower pultrudate. According to the invention it is provided that grooves and elevations interact with one another, that is to say that elevations of the upper pultrudate engage in depressions of the lower pultrudate or depressions of the upper pultrudate engage in elevations of the lower pultrudate.

Advantageously, the grooves and elevations keep the adjacent pultrudates spaced apart from one another and simultaneously prevent uncontrolled lateral displacement of the pultrudates.

The elevations are preferably interrupted in the longitudinal direction at predetermined intervals. In the interrupted portions the elevations can be returned to the level of the surface of the pultrudate. The interruptions allow resin to flow through the interruption of the elevations along the width, preferably the complete width of the pultrudates which are lying above one another.

Particularly preferably, grooves have a first width and the elevations have a second width, and the first width is about 5 mm to 20 mm greater than the second width.

The grooves advantageously have a width of 8 mm to 30 mm and the elevations advantageously have a width of 2 mm to 10 mm.

It is advantageous to form the pultrudates homogeneously in the longitudinal direction and always to use the same pultrudates alongside and above one another to form a component of a rotor blade, that is to say to lay the same type of pultrudate alongside and above one another. In particular during laying of the pultrudates above one another, that is to say during stacking of the pultrudates, the grooves and elevations of adjacent pultrudates engage in one another. Since the elevations have a smaller width than the grooves, the pultrudates can be displaced with respect to one another along the width as they are fitted into one another. In this way it is possible to bend the pultrudate stack in cross-section in both directions without the elevations sliding out from the grooves. The different width compensates for the different radii or curvatures of the top and bottom side at each thickness position of the pultrudate stack.

In a second aspect the object is achieved by an above-mentioned component with the features of claim 5.

The component has at least two pultrudates arranged above one another, wherein a top side of a pultrudate is arranged adjacent to a bottom side of an adjacent pultrudate.

The component is preferably produced from the above-mentioned pultrudates. According to the invention the bottom side has elevations and/or grooves running in the longitudinal direction and the top side of the adjacent pultrudate has corresponding grooves and/or elevations which are inserted into one another and which keep the adjacent pultrudates at a predetermined distance from one another. The distance between the two adjacent pultrudates is for instance 0.05 mm to 0.5 mm. However, other distances are also conceivable, and every distance in the tenths of a millimetre range is hereby disclosed.

The distance between the adjacent pultrudates makes it possible that in a vacuum infusion process resin runs through uniformly between the adjacent pultrudates and completely wets the top side of the lower pultrudate and the bottom side of the upper pultrudate and cures in the subsequent heating process and connects the two pultrudates firmly to one another.

The pultrudates running in the longitudinal direction are preferably all of the same shape. Thus the pultrudates can be cut to size from a pultrudate roll or a pultrudate web and stacked one above the other and arranged alongside one another. The design of the component is particularly cost-effective.

Advantageously, continuous elevations are formed on the top side and continuous grooves are formed on the bottom side, whilst the elevations and the grooves are arranged directly above one another along the height of the pultrudate, that is to say they are at the same distance from the side edges of the pultrudate.

The above-mentioned interruptions of the elevations of the pultrudates make it possible for an infusion process to be carried out not only in the longitudinal direction but also along the width of the pultrudates, so that the resin can be infused between the pultrudates, and although the elevations lie in the valleys of the grooves, the resin is able to pass through in the regions of interruptions of the elevations, so that the entire surface area between the pultrudates can be wetted with the resin system.

Preferably the elevations are approximately semi-circular in cross-section and the grooves are approximately elliptical in cross-section. In this case the width of the groove is greater by 5 mm to 20 mm than the width of the elevation, so that the adjacent pultrudates can be shifted cross-sectionally with respect to one another along the width, so that in the infusion process, in which the pultrudate stacks are drawn against the contact surface of a curved production mould and are adapted to the curvature, the adjacent pultrudates are displaced relative to one another, without the elevation of one pultrudate springing out of the groove of the adjacent pultrudate, but is merely shifted along the cross-section inside the groove. Furthermore, the semi-circular or elliptical design facilitates self-centring in the unbent pultrudates, which is preferred.

The object is achieved in a third aspect by a production method having the features of claim 8.

According to the invention resin-impregnated fibres are guided through a pre-mould which has elevations and/or grooves on a top side and a bottom side and as a result grooves or elevations are moulded in reverse into a matrix of the resin system.

The elevations are formed during the usual pultrusion process for producing a pultrudate and run continuously in the longitudinal direction of the pultrudate. Pultrudates are usually produced from fibres and a resin system. The fibres are wound on spindles or rolls in the form of, for example, glass fibres or carbon fibres and are fed for example via a grid to a resin bath and then to a pre-mould, in which the fibres are adhered to one another by the received resin system. The resin-soaked fibres are fed to the pre-mould in a small broad rectangle which corresponds to the cross-section of the pultrudate.

A top side and bottom side of the pre-mould station has grooves or depressions into which or out of which the resin system with the fibres is pressed, so that the top side and bottom side of the pultrudate have the reversed elevations and/or grooves according to the invention on the predetermined lines which extend in the longitudinal direction over the entire top side and bottom side of the pultrudate.

In a subsequent process step the pultrudate is cured, so that the grooves and the elevations remain permanently fixed on the top side and bottom side of the pultrudate. The curing preferably takes place by heating or preferably by irradiation with UV light.

In a preferred embodiment of the method for producing pultrudates, interruptions are introduced at predetermined intervals into the elevations of the pultrudates in a subsequent step. This can take place by a grinding method or similar methods.

In its fourth aspect, the object is achieved by a method of production having the features of claim 9, wherein pultrudates according to claim are arranged above one another and a resin infusion process is carried out.

The method of production is suitable in particular for producing girders for rotor blades which are formed from three to five pultrudates arranged alongside one another and up to 20 pultrudates arranged adjacently above one another. Adjacent pultrudates are understood here as the pultrudates which are stacked one above the other, with their top and bottom sides lying on top of one another and spaced apart from one another by the groove and elevation principle. The infusion process is carried out in a conventional manner.

The invention is described with reference to an embodiment in three drawings. In the drawings:

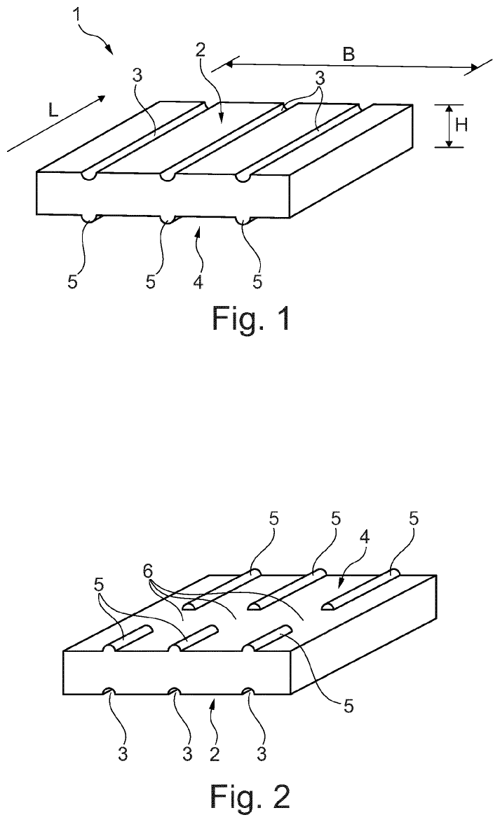

FIG. 1 shows a pultrudate according to the invention in a view from above,

FIG. 2 shows the pultrudate in FIG. 1 in a view from below,

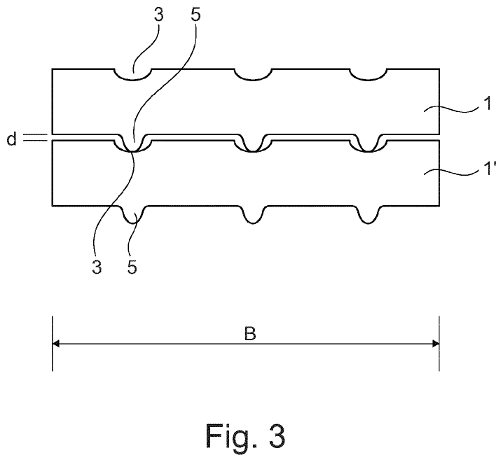

FIG. 3 shows a stack of two pultrudates according to the invention according to FIG. 1 for producing a girder.

A pultrudate 1 according to the invention is illustrated in FIG. 1. Pultrudates 1 are extruded fibre-reinforced plastic components. Pultrudates 1 are usually produced by unrolling rovings, which are bundles of fibres stored on spindles or rolls.

The rovings/fibres are impregnated with resin after the unwinding in a suitable form. The resin-impregnated fibres are then drawn through a pre-mould station. They are then arranged alongside and above one another in a flat rectangular cross-section and are adhered to one another and brought into the pultrudate shape illustrated in FIG. 1. In the pre-mould protrusions are provided on a top side and grooves are provided on a bottom side, so that correspondingly in the preformed pultrudate 1 grooves 3 are formed on its top side 2 and elevations 5 are formed on its bottom side 4 when the pultrudate 1 is drawn through the pre-mould. Then the pultrudate 1 is cured.

A cross-section of the pultrudate 1 is illustrated in FIG. 1, wherein the pultrudate 1 is penetrated in cross-section to a large extent by fibres which also extend along the elevations 5 and in each case over the entire extent of the pultrudate 1 and also inside the elevations 5 in the longitudinal direction L of the pultrudate 1. Pultrudates 1 usually have widths of B=100 mm to 300 mm and heights of H=5 mm to 20 mm. These are endless components which can be wound on a roll after curing and thus can be transported to the place of use. Depending upon the degree of curing the pultrudates 1 are differently flexible. Completely cured pultrudates can actually be bent only with great difficulty, in particular in cross-section the pultrudates can hardly be bent, and in longitudinal section the pultrudates 1 can merely be wound up with a large radius.

FIG. 2 shows the pultrudate in FIG. 1 in a view from below. In the view from below it is crucial that the elevations 5 which are formed from the bottom side 4 of the pultrudate 1 in the longitudinal direction L are interrupted at intervals by interruptions 6. The elevations 5 are abraded along the interruptions 6 and are ground down to the height of the bottom side 4 of the pultrudate 1. The interruptions 6 make it possible that during a resin infusion process for producing a girder the resin flows through along the entire width B of the pultrudate 1 between two superimposed pultrudates 1.

A cross-section of a part of a girder structure using pultrudates 1 is illustrated by way of example in FIG. 3. In cross-section, girders are usually formed of three to five pultrudates 1 arranged alongside one another and up to ten pultrudates 1, 1′ arranged one above the other. The pultrudates 1, 1′ can be arranged above one another in stacks, but they can also be arranged in a group.

FIG. 3 shows that the elevations 5 on the bottom side 4 of the pultrudate 1 correspond to the grooves 3 on the top side 2 of an adjacent pultrudate 1′, that is to say that in the case of pultrudates 1 laid on top of one another the elevations 5 of one pultrudate 1 engage completely in the grooves 3 of the adjacent other pultrudate 1′. The elevations 5 are guided along their entire longitudinal extent in the grooves 3 of the adjacent pultrudate 1′.

The grooves 3 usually have a width of 8 to 30 mm, whilst the elevations 5 have a width of 2 to 10 mm, so that the elevations 5 do not completely fill the cross-section of the grooves 3 but are displaceable to and fro inside the grooves 3 along the width B. This different dimensioning of the elevations 5 and the grooves 3 is necessary because during the formation of the girder and during the infusion process the pultrudates 1 are pressed against the contact surface of a production mould and are bent in cross section. In order that a pultrudate 1 is not pressed out of the groove 3 of the adjacent other pultrudate 1′, the grooves 3 must have a greater width than the elevations 5, so that a relative movement of the grooves 3 with respect to the elevations 5 is possible which compensates for a different curvature.

Since the elevations 5 and the grooves 3 extend over the entire longitudinal extent of the pultrudate 1, interruptions 6 of the grooves illustrated in FIG. 2 are helpful and even necessary, so that during an infusion process the still liquid resin system can also flow through along the width B in FIG. 3 from right to left or left to right between the two pultrudates 1, 1′ which lie above one another. In this case the height of the elevations 5 of the pultrudate 1 is chosen to be greater than the depth of the grooves 3 of the adjacent pultrudate 1′, so that the pultrudates 1, 1′ do not lie completely directly on top of one another, but are spaced apart from one another at a distance d. The distance d is between d=0.05 mm and d=0.2 mm, that is to say in the tenths of a millimetre range. It is large enough that the resin system can be distributed completely between the pultrudates 1, 1′ and so an optimal adhered connection between the two pultrudates 1, 1′ can be produced.

The top and bottom sides 2, 4 of the pultrudate 1 according to FIG. 1 and FIG. 2 are usually provided with a peel ply which is laid at the top and at the bottom onto the not yet cured resin system on the top side 2 or the bottom side 4 and is peeled off after the curing and leaves behind a rough surface on the top and bottom sides 2, 4, so that the resin infused between the pultrudates 1, 1′ has a surface which is particularly large, because it is rough, available for adhesion and thus a very firm adhesive connection can be produced between the individual pultrudates 1, 1′.

### LIST OF REFERENCE NUMERALS

1 pultrudate

1′ adjacent pultrudate

2 top side

3 grooves

4 bottom side

5 elevations

6 interruptions

B width

d spacing

L longitudinal direction

1. Pultrudate (1) with fibres running in the longitudinal direction (L) and a resin matrix which surrounds the fibres, and a top and a bottom side (2, 4), characterized in that the top side (2) has continuous elevations (5) and/or grooves (3) and the bottom side (4) has continuous grooves (3) or elevations (5), which are arranged such that elevations (5) and grooves (3) of one pultrudate (1) interact with grooves (3) and elevations (5) of the adjacent pultrudate (1′).

2. Pultrudate according to claim 1, characterized in that the elevations (5) are interrupted at predetermined intervals (d) in the longitudinal direction (L).

3. Pultrudate according to claim 1 or 2, characterized in that the grooves (3) have a first width and the elevations (5) have a second width, and the first width is about 5 mm to 20 mm greater than the second width.

4. Pultrudate according to claim 1, 2 or 3, characterized in that the grooves (3) have a width of 8 to 30 mm and the elevations (5) have a width of 2 mm to 10 mm.

5. Component of a rotor blade having at least two pultrudates (1, 1′) arranged above one another, wherein a top side (2) of a pultrudate (1) is arranged adjacent to a bottom side (4) of an adjacent pultrudate (1′), characterized in that a bottom side (4) of the pultrudate (1) has elevations (5) and/or grooves (3) running in the longitudinal direction (L), a top side (2) of the adjacent pultrudate (1′) has corresponding grooves (3) and/or elevations (5), and corresponding grooves (3)/elevations (5) are inserted into one another and keep the adjacent pultrudates (1, 1′) at a predetermined distance (d) from one another.

6. Component according to claim 5, characterized in that grooves (3) are formed alongside one another on the bottom side (4) of the pultrudates (1) and continuous elevations (5) are formed on the top side (2).

7. Component according to claim 5 or 6, characterized in that the pultrudates (1, 1′) are spaced apart from one another by 0.05 mm to 0.5 mm.

8. Method of producing a pultrudate (1, 1′), resin-impregnated fibres being guided through a pre-mould which has elevations and/or grooves on a top side (2) and a bottom side (4) which form grooves and/or elevations into the top side (2) and the bottom side (4) of the pultrudate (1, 1′).

9. Method of production for a component of a rotor blade, pultrudates (1, 1′) according to claim 1 being arranged above one another and a resin infusion process is carried out.
